(19) United States
(12) Patent Application Publication
(10) Pub. No.: US 2007/0132229 A1
(43) Pub. Date: Jun. 14, 2007

(54) Coupling of conduits with a channel

(75) Inventors: Jochen Mueller, Karlsruhe (DE); Bertram Beigel, Karlsruhe (DE)

Correspondence Address: Paul D. Greeley;Ohlandt , Greeley, Ruggiero & Perle, L.L.P., 10th Floor, One Landmark Square, Stamford, CT, 06901-2682, US

(73) Assignee: Agilent Technologies, Inc.

(21) Appl. No.: 11/302,659

(22) Filed: Dec. 14, 2005

(51) Int. Cl. F16L 39/00

(52) U.S. Cl. 285/124.2

(57) ABSTRACT

A coupling for bringing a first conduit in communication with a second conduit. Each of the conduits has an end to be coupled. Each of the conduits is adapted for conducting a fluid. The coupling has a channel adapted for channeling said fluid from said first conduit into said second conduit. Furthermore, the coupling comprises a seal adapted for sealing and receiving said ends of said first and second conduits. The seal is adapted for sealing said channel.

### BACKGROUND ART

1. Field of the Invention

The present invention relates to coupling conduits.

2. Discussion of the Background Art

Couplings are used for allowing conduits adapted for conducting a medium to communicate. Known are, for example, light guides or fluid conduits for conducting light or a fluid, for example a liquid. A capillary, for example, can serve as a fluid conduit and as a light guide. Flow cells, for example, for analyzing a fluid can comprise a fluid conduit and a light conduit or better known as a light guide. Flow cells can comprise different conduits communicating via one or more connections.

U.S. Pat. No. 6,526,188 B2 and the US 2001/0010747 show a modular flow cell having a high optical throughput, a long optical path length and a small cross-section. The modular flow cell configuration includes remote ports or connections for liquid and light input and liquid and light output.

U.S. Pat. No. 5,444,807 shows a flow-through cell for use in the measurement of chemical properties of small volumes of fluid containing dissolved analytes.

U.S. Pat. No. 5,608,517 discloses a coated flow cell and a method for making the coated flow cell. The flow cell comprises a flow passage, wherein light directed into the flow cell is internally reflected down the flow passage.

U.S. Pat. No. 3,236,602 discloses flow cells and holders therefore, the calorimetric examination of a liquid to determine the quantity of a substance present in the liquid.

U.S. Pat. No. 4,477,186 discloses a photometric cuvette for optical analyses of through-flowing medium, made as a thin and narrow transparent tube requiring minimum sample amounts. Light, substantially parallel to the tube length, is led obliquely into the tube through its wall, is reflected and is led obliquely out through the tube wall to a detector.

EP 008915781 discloses an optical detector cell for determining the presence of a solute in a sample fluid. The optical detector cell includes a sample tube, inlet and outlet means for the sample fluid, and a first and second optical waveguide for passing a beam of light axially through the sample tube.

GB 2193313 A discloses an apparatus and method for measuring the spectral absorbance of fluid samples. The length of the light path through the sample is adjusted to optimize the amount of light absorbed by the sample.

U.S. Pat. No. 6,281,975 B1 shows a bent capillary flow cell with protruding end bulbs coaxial with centerline of an elongated centre cylindrical section of capillary tubing. The bulbs provide a high light throughput entrance window for the cell.

### SUMMARY OF THE INVENTION

It is an object of the invention to provide an improved coupling of conduits. The object is solved by the independent claims. Further embodiments are shown by the dependent claims.

According to embodiments of the present invention, a coupling for bringing a first conduit in communication with a second conduit is suggested. Each conduit comprises an end to be coupled and is adapted for conducting a fluid, for example a gas or a liquid. The coupling comprises a channel. Advantageously, the channel is adapted for channeling the fluid from the first conduit into the second conduit and/or reversed. The channel can be used for fluidically connecting the two conduits. For avoiding any leakage flow, the coupling can comprise a seal.

Advantageously, the seal can be adapted for receiving the ends of the first and second conduit. By this, the seal can, for example, surround the ends of the conduits in a sealing contact for avoiding any leakage flow of the fluid conducted within the two conduits. Additionally, the seal can be adapted for sealing the channel against any leakage flow towards the environment.

For this purpose, the seal can surround the ends of the first and second conduits and the channel. For composing the coupling, the ends of the first and second conduits can be inserted into an according breakthrough of the seal, wherein the seal comprises a first aperture adapted for receiving the first conduit and a second aperture adapted for receiving the second conduit, wherein the first and second apertures are fluidically coupled to the channel within the seal or better within an inner loop or breakthrough of the seal.

Embodiments may comprise one or more of the following: Possibly, the channel can comprise a forking, wherein each branch of the forking is coupled to an aperture or groove. In other words, the coupling or rather the seal of the coupling comprises a plurality of apertures adapted for receiving a plurality of ends of conduits. Possibly, each of the apertures can comprise a groove. Possibly, the seal can comprise a half-shell comprising the channel and the first and second apertures or the plurality of apertures and the forking.

Embodiments may comprise one or more of the following. The coupling can comprise a support member, wherein the support member is surrounded at least partly by the seal. For this purpose, the support member can comprise the channel and the first and second apertures or the plurality of apertures and the forking. Advantageously, the complete support member comprising the channel connecting the first and second conduits and the ends of the first and second conduits can be sealed by the seal against any.

The support member can be adapted for positioning and/or supporting the first and second conduits. Advantageously, the outlets of the first and second conduits and the channel itself can be separated from the seal surrounding the support member. By this, it can be avoided that the ends or rather the outlets of the first and second conduits are plugged by the seal.

Embodiments may comprise one or more of the following. At least one of that said conduits can be adapted for conducting light. Advantageously, the coupling can couple a first fluidic conduit and a second fluidic conduit via the channel, wherein at least one of the fluidic conduits is coupled additionally to the wave guide adapted for conducting light. For example, the first fluidic conduit can comprise a first capillary coupled to a first wave guide by the coupling and the second fluidic conduit can comprise a second capillary coupled to a second wave guide by the coupling. The first and the second wave guides can be arranged coaxially to the according first and second capillary.

Besides this, the first capillary and the first wave guide can be arranged substantially in a parallel to the second wave guide coupled to the second capillary. For coupling the first and second wave guides to the first and second capillary, optical outlets of the first and second wave guides can be inserted into fluidic outlets of the first and second capillary.

Further embodiments of the invention relate to a fluidic system. The fluidic system comprises a coupling. Besides this, the fluidic system can comprise a flow cell adapted for housing a fluid sample and for exposing the fluid sample to radiation for analysis and to a fluidic system. The flow cell and the fluidic system can comprise said coupling for bringing a first conduit in communication with a second conduit. Furthermore, the flow cell can comprise two capillaries and two wave guides coupled by the coupling. Advantageously, for example, the capillaries can be connected in series by the coupling. In other embodiments, the capillaries can be fluidically coupled parallel by the coupling.

Advantageously, the coupling can be used for fluidic systems requiring a low dead volume. Fittings and/or connecting conduits possibly significantly increasing the dead volume are not necessary. A plurality of flow cells can be coupled to a complete fluidic system by the coupling or a plurality of such couplings, wherein just the channel increases the dead volume. For this purpose, advantageously, the channel of the coupling can comprise a relative small-sized cross-sectional area, for example, a similar cross-sectional area as inner tubes of said capillaries providing a fluid path.

### BRIEF DESCRIPTION OF THE DRAWINGS

Other objects and many of the attendant advantages of embodiments of the present invention will be readily appreciated and become better understood by reference to the following more detailed description of embodiments in connection with the accompanied drawings. Features that are substantially or functionally equal or similar will be referred to by the same reference signs.

FIG. 1 shows a 3-dimensional top view of a half shell of a coupling comprising a foil,

FIG. 2 shows a 3-dimensional top front view of a part section of a coupling comprising a doughnut-shaped seal,

FIG. 3 shows a cross-sectional view of the coupling of FIG. 2, taken along the lines III-III of FIG. 2,

FIG. 4 shows a cross-sectional view of the coupling of FIG. 1, taken along the lines IV-IV of FIG. 1,

FIG. 4A shows a detailed view of FIG. 4 illustrating another embodiment of the coupling,

FIG. 5 shows a schematic top view of an arrangement of two flow cells, each comprising a fluid path and a light path, wherein the fluid path and the light paths are connected in a counter-current manner,

FIG. 6 shows a schematic top view of an arrangement of three flow cells connected in series and comprising co-current flow and counter-current flow connected fluid and light paths,

FIG. 7 shows a schematic top view of an arrangement of three flow cells connected in series and in parallel,

FIG. 8 shows a schematic top view of an arrangement of three flow cells connected in series, each comprising fluid and light paths coupled in a co-current flow manner,

FIG. 9 shows a schematic top view of an arrangement of three flow cells, wherein the light paths and the fluid paths are connected in parallel, and wherein the light paths and fluid paths are coupled in a co-current flow manner, and

FIG. 10 shows a schematic view of a fluidic system comprising two flow cells connected in series.

### DETAILED DESCRIPTION OF THE PREFERRED EMBODIMENT

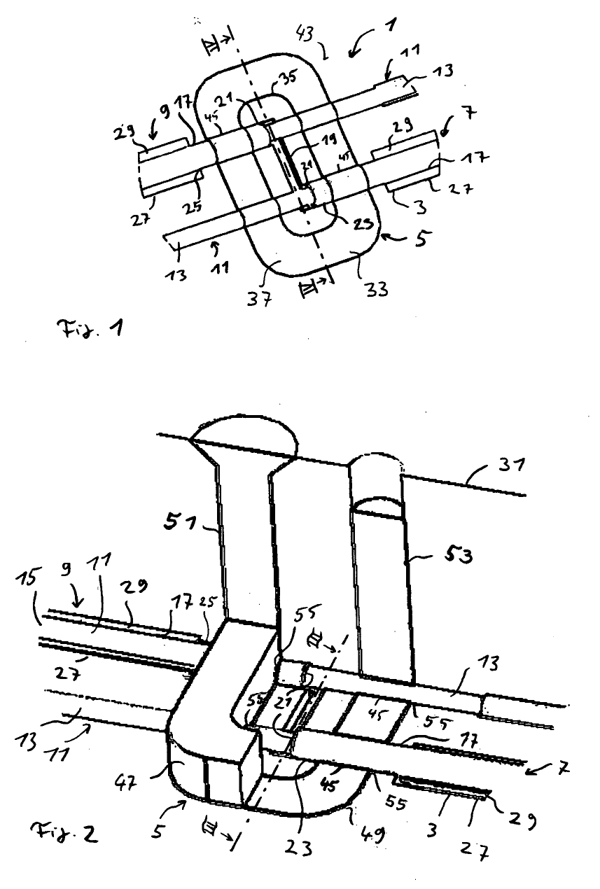

FIG. 1 shows a 3-dimensional top view of a coupling 1 comprising a half shell 3 and a seal 5.

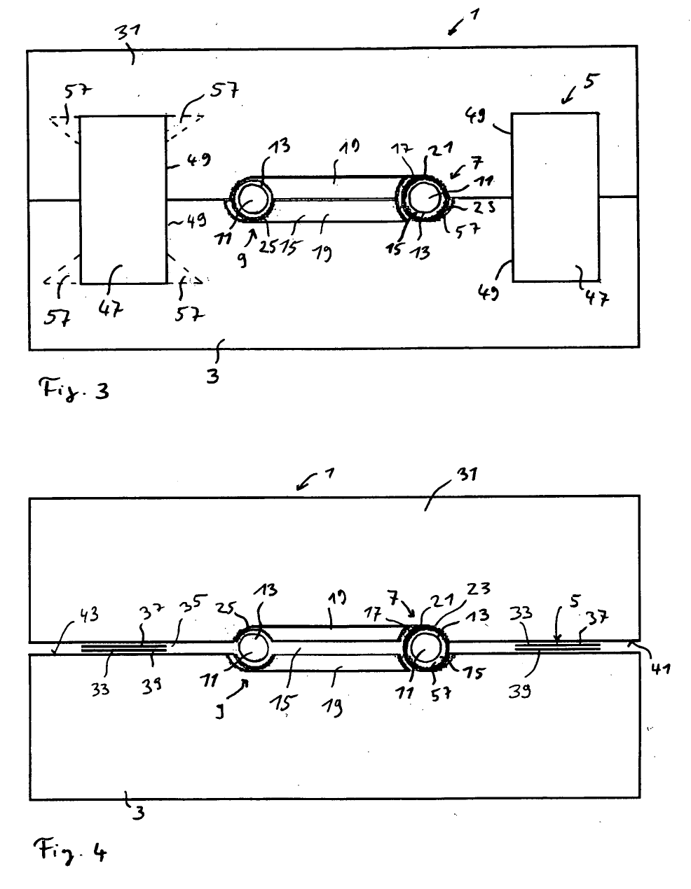

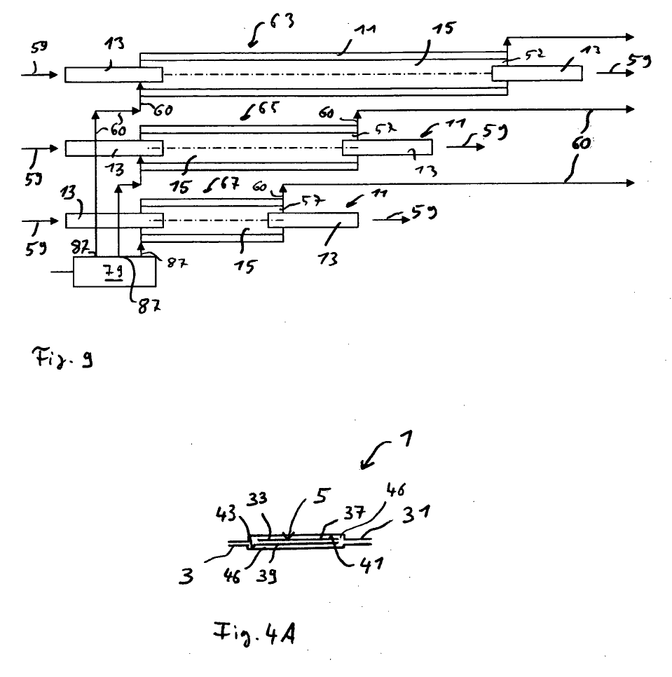

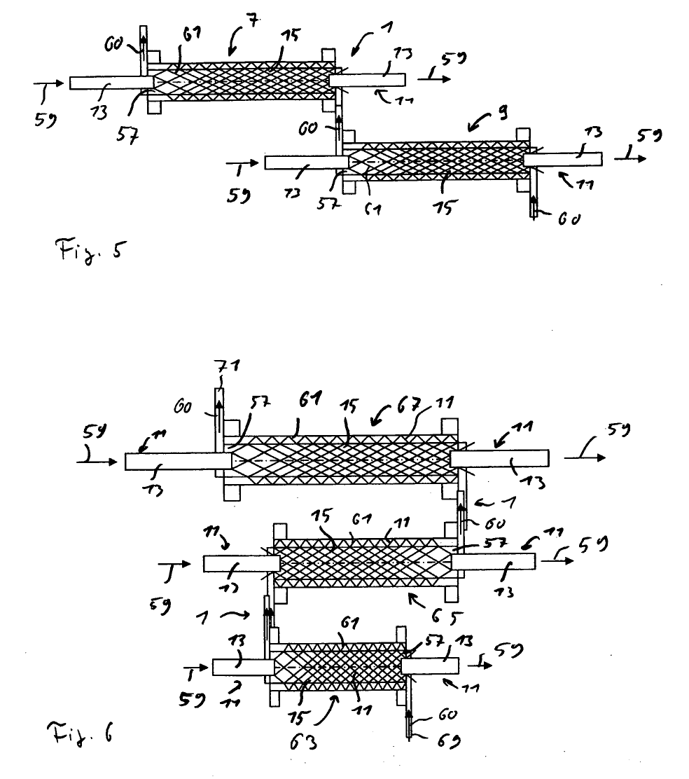

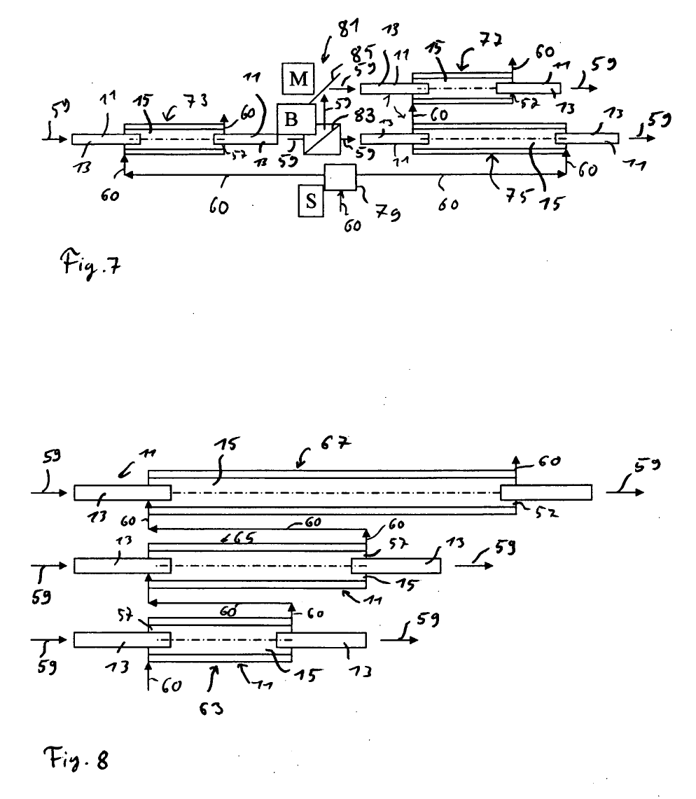

The coupling 1 is adapted for coupling a first flow cell 7 with a second flow cell 9. Each of the first and second flow cells 7 and 9 comprises a light path 11 comprising a wave guide 13 and a fluid path 15, comprising a capillary 17. The coupling 1 is adapted for fluidically coupling the fluid paths 15 of the first and second flow cells 7 and 9 in series. For this purpose, the coupling 1 or rather the half shell 3 of the coupling 1 comprises a channel 19 adapted for connecting ends 21 of the capillaries 17 of the firstand second flow cells 7 and 9. The channel 19 can be realized, for example, as a groove of the half shell 3 and can provide a microfluidic fluid path. The channel 19 of the half shell 3 ends up in a first aperture 23 adapted for at least partly receiving the end 21 of the first flow cell 7. Besides this, the half shell 3 of the coupling 1 comprises a second aperture 25 adapted for at least partly receiving the end 21 of the second flow cell 9, wherein the channel 19 ends up in the second aperture 25. The first and second apertures 23 and 25 can be realized, for example, as half-pipe-shaped grooves of the half shell 3. Aperture can be understood as a half-pipe-shaped groove. Besides this, aperture can be understood as a combination of two opposed mounted half-pipe-shaped grooves, wherein the two grooves can be combined to a substantially circular shaped opening or aperture. For this purpose, the half shell 3 can be combined with a cover shell 31 as shown in FIG. 3 and 4.

Advantageously, the coupling 1 and the flow cells 7 and 9 coupled by the channel 19 can be integrated in one device, wherein any dead volume and the total amount of component parts can be reduced to a minimum. Besides this, the channel 19 can be branched or better can comprise a forking for providing a splitting device for the fluid path 15. Consequently, the splitting device can also be integrated in said one device.

Furthermore, the half shell 3 comprises two recesses 27 adapted for at least partly receiving the capillaries of the first and second flow cells 7 and 9, wherein between the outer surfaces of the capillaries 17 of the first and second flow cells 7 and 9 and the recesses 27 remains an air gap 29.

FIG. 4 shows a cross-sectional view of the half shell 3 of the coupling 1 of FIG. 1 together with the cover shell 31 of the coupling 1, taken along the lines in IV-IV of FIG. 1. In the following, by referring to the FIG. 1 and 4, the design of the seal 5 of the coupling 1 is described.

The seal 5 comprises a foil 33 surrounding the channel 19. The foil 33 of the seal 5 of the coupling 1 can be doughnut-shaped, wherein the channel 19 lays in an inner loop 35. The inner loop 35 can be realized as a break-through within the foil 33.

Possibly, the inner loop 35 of the seal can be used for conducting the fluid between the flow cells 7 and 9. The shells 3 and 31 can be joined together via the seal 5 in a small distance to each other. By this, the seal 5 can provide the channel of the coupling 1, wherein the clearance between the shells 3 and 31 within the loop of the seal 5 provides a fluid path between the flow cells 7 and 9. Consequently, if desired, the groove scribed in at least one of the shells 3 and 31 can be dropped. Furthermore, the inner loop 35 of the seal 5 can be reduced to a small slit or groove providing the channel of the coupling 1. Finally, the seal can 5 be extended to a layer or a plurality of layers adapted to the size of the surfaces 43 and 41 of the shells 3 and 31. At least one of said layers can comprise the channel. The shells 3 and 31 can be joined together via the seal 5 in a small distance to each other.

As shown in FIG. 4, the foil 33 of the seal 5 comprises a top layer 37 and a bottom layer 39. The top layer 37 of the seal 5 is coupled in a fluid-tight manner to a surface 41 of the cover shell 31. The bottom layer 39 is coupled in a fluid-tight manner to a surface 43 of the half shell 3 of the coupling 1. The half shell 3 and the cover shell 31 can be substantially symmetrically designed. By this, the first and second apertures 25 of the coupling I are realized by according grooves of the half shell 3 and the cover shell 31. For realizing a complete fluid-tight seal 5 for the channel 19 and the first and second flow cells 9, the top layer 37 and the bottom layer 39 are additionally in a sealing contact with spans 45 of the according grooves of the first and second apertures 25 of the half shell 3 and the cover shell 31.

Summarizing, the top layer 37 and the bottom layer 39 are in contact with each other in a fluid-tight manner. Besides this, the top layer 37 and the bottom layer 39 are in contact with the according outer surfaces of the capillaries 17 and the wave guides 13 of the first and second flow cells 7 and 9, the spans 45 of the grooves of the first and second apertures 23 and 25, and with the half shell 3 and the cover shell 31, each in a fluid-tight manner.

For realizing the fluid-tight sealing contact of the top layer 37 and the bottom layer 39 with the according components of the coupling 1 and with each other, the half shell 3 and the cover shell 31 can be pressed to each other, for example, by screws, by a clamping device, hydraulic forces, and/or alike. Possibly, the top layer 37 and the bottom layer 39 can comprise a foil 33 that can be activated by heating, for example by executing a heat sealing process. Besides this, the sealing contact of the top layer 37 and the bottom layer 39 can be realized by adhesives.

FIG. 4A shows a detail of FIG. 4 showing the seal 5 in a sealing contact with the surfaces 41 and 43 of the shells 31 and 3 of the flow cell 1. As shown in FIG. 4A, possibly, the seal 5 can be embedded in recesses 46 of the shells 31 and 3. Possibly, the recesses 46 can slightly less deep as the thickness of the layers 37 and 39 of the foil 33 of the seal 5. By varying said deepness of the recesses 46 and the thickness of the layers 37 and 39, the sealing forces of the seal 5 can be adjusted and/or limited. Furthermore, by this, the surfaces 41 and 43 of the cover shell 31 and the half shell 3 can be flushly joined together.

FIG. 2 shows a 3-dimensional top front view of a part section of a coupling 1 comprising a doughnut-shaped seal 1. The seal 1 of the coupling 1 comprises a plastic material 47. The plastic material 47 of the seal 1 is shown partly in FIG. 2. The plastic material 47 of the coupling 1 comprises, for example, an elastic material.

Furthermore, the plastic material can comprise, an elastomeric material, a thermoplastic material, polyetheretherketone (PEEK), one of a broad range of flouropolymeres, in particular perfluoroamines (PFA) or flourinated ethylen-propylene copolymer (FEP), duroplastic material or compound, in particular polyimide, liquid crystal polymers (LCP), and/or alike.

For realizing the seal 5 of the coupling 1 as shown in FIG. 2, the plastic material 47 can be injected as a fluid into circular or doughnut-shaped recesses 49 of the half shell 3 and the cover shell 31 of the coupling 1. For this purpose, the cover shell 31 of the coupling 1 can comprise an injection channel 51 and a mold vent channel 53. In further embodiments, plastic material can simply be inserted into the recesses 49. For assembling the coupling 1, the wave guides 13 and the capillaries 17 of the first and second flow cells 7 and 9 can be inserted into apertures 55 of the plastic material 47 of the seal 5.

FIG. 3 shows a cross-sectional view of the coupling 1 of FIG. 2, taken along the lines III-III of FIG. 2. As can be seen in FIG. 3, the cross sections of the recesses 49 of the cover shell 31 and the half shell 3 of the coupling 1 are rectangular shaped. Possibly, the cross sections of the recesses 49 can comprise any other shape; can be, for example, half-pipe-shaped. Possibly, the recesses 49 of the shells 3 and 31 can comprise undercuts 56 for improving the sealing effect, as exemplarily shown on the left hand side of FIG. 3 by dashed lines. The plastic material 47 of the seal 5 being located in the recesses 49 surrounds the channel 19 of the coupling 1, wherein a sealing effect is realized at the surfaces of the recesses 49 and the outer surfaces of the wave guides 13 and the capillary 17 of the first and second flow cells 7 and 9 at the spans 45 of the capillaries 17 and the wave guides 13. By this, any fluid leakage toward the outside of the coupling 1 can be avoided by the seal 5. As can be seen in the FIG. 3 and 4, the cover shell 31 also comprises a channel 19 being oppositely arranged to the channel 19 of the half shell 3 of the coupling 1. Possibly, just one of the shells 3 or 31 comprises a channel 19.

For connecting the light paths 11 and the fluid paths 15 of the first and second flow cells, the optical outlets of the wave guides 13 are inserted into inner tubes 57 of the according capillaries 17. By this, the fluid conducted within the capillaries 17 of the first and second flow cells 7 and 9 can be irradiated by the optical outlets of the wave guides 13.

The elastic or elastomeric material can be pressurized by at least one pin inserted into one of the channels 51 or 53 of the cover shell 31 leading into the recesses 49 forming a cavity.

Possibly, said seal can comprises a low pressure seal comprising the solvent resistant material, for example, an elastomeric material and a high pressure seal comprising an adhesive which is not in contact with the solvent or fluid.

FIG. 5 shows a schematic top view of an arrangement of the first and second flow cells 7 and 9 being connected by the coupling 1. The capillaries 17 of the first and second flow cells 7 and 9 as shown in FIG. 5 are fluidically coupled in series. The light paths 11 of the first and second flow cells 7 and 9 are connected in parallel. Each of the first and second flow cells 7 and 9 are operated in a counter-current flow manner. Operating a flow cell in a counter-current flow manner can be understood as sending the light of the light path 11 of the flow cell in the opposite direction through the capillary 17 as the fluid within the inner tube 57 of the capillary 17.

The direction of the light guided through the wave guides 13 and the capillaries 17 are indicated by arrows 59. The flow direction of the fluid paths 15 of the flow cells 7 and 9 are indicated by arrows 60. Besides this, different beams of the light paths 11 of the first and second flow cells 7 and 9 are indicated by a plurality of lines 61.

As shown in FIG. 5, within the wall of the capillaries 17, at the transition of the outer surface of the capillary 17 and the air gap 29 (FIG. 1 or FIG. 2), total reflection of the beams—as indicated with the lines 61—occurs. The light of the light paths 11 can be guided though a fluid conducted within the inner tubes 57 of the first and second flow cells, wherein the fluid can comprise a sample to be analyzed.

FIG. 6 shows a schematic top view of an arrangement of a first flow cell 63, a second flow cell 65 and a third flow cell 67. The fluid paths 15 of the flow cell 63, 65 and 67 of the arrangement as shown in FIG. 6 are fluidically connected in series by a first coupling 1 and a second coupling 1, for example, as shown in the FIG. 1-4. The light paths 11 of the three flow cells 63, 65 and 67 of the arrangement are connected in parallel. Each of the light paths 11 can be connected with a not shown light source adapted for coupling light into the light paths 11. On the other side, in direction of FIG. 6 right hand sided, the light paths 11 can be coupled to not shown detectors adapted for determining the amount of light guided through the flow cells 63, 65 and 67.

For metering fluid into the fluid paths 15 of the flow cells 63, 65, 67, an inlet port 69 of the first flow cell 63 can be coupled to a not shown fluid source, for example a pump, a nanopump, and/or alike. Accordingly, an outlet port 71 of the third flow cell 67 can be coupled to a waste or to an arbitrary downstream device. In difference to the arrangement of FIG. 5, the flow cells 63, 65 and 67 are operated in a combined flow manner, wherein the first flow cell 63 and the third flow cell 67 are operated in a counter-current flow manner and the second flow cell 65 is operated in a co-current flow manner. Co-current flow manner can be understood as operating a flow cell in a way that the light and the fluid is guided through the flow cell in the same direction.

FIG. 7 shows a schematic top view of an arrangement of a first flow cell 73, a second flow cell 75, and a third flow cell 77. The flow direction of the fluid paths 15 of the flow cells are indicated by arrows 60.

In difference, the first flow cell 73 and the second flow cell 75 are fluidically connected in parallel. For this purpose, the fluid path 15 of the arrangement as shown in FIG. 7 can comprise a forking device 79 for manifolding the flow into the first and second flow cells 73 and 75. The forking device 79 can be analogously designed as on of the couplings 1 of one of the FIGS. 1 to 4.

The first flow cell 73 can be coupled downstream to a not shown waste or an additional device. The second flow cell 75 is fluidically coupled downstream to the third flow cell 77. In other words, the second flow cell 75 and the third flow cell 77 are fluidically coupled in series, wherein the third flow cell 77 can be coupled downstream to a waste or to a not shown additional device.

The light path 11 of the arrangement or rather of the first, second, and third flow cell 73, 75 and 77 is branched. Therefore, the arrangement comprises a light manifolding device 81. For this purpose, the light manifolding device 81 can comprise a semi-transparent mirror 83 adapted for splitting the light beam and a mirror 85. The light path 11 conducted through the first flow cell 73 is forked in two light paths 11 of the second flow cell 75 and the third flow cell 77. By this, the second flow cell 75 and the third flow cell 77 or rather the wave guides 13 of the second and third flow cells 75 and 77 can be coupled to a not shown light detector. The direction of the light directed through the light paths is indicated by the arrows 59.

The first flow cell 73 and the third flow cell 77 are operated in a co-current flow manner. The second flow cell 75 is operated in a counter-current flow manner.

FIG. 8 shows a schematic top view of an arrangement of three flow cells 63, 65, and 67. In difference to the arrangement as shown in FIG. 6, all flow cells 63, 65, and 67 are operated in a co-current flow manner. The forking device 79 can be analogously designed as on of the couplings 1 of one of the FIGS. 1 to 4.

FIG. 9 shows an arrangement of three flow cells 63, 65, and 67. In difference to the arrangements as shown in FIG. 6 and FIG. 8, the arrangement of FIG. 9 comprises three flow cells 63, 65, and 67 fluidically coupled in parallel. For this purpose, the fluid paths 15 of the arrangement of FIG. 9 comprises a forking device 79 comprising three branches 87, wherein each of the three flow cells 63, 65, and 67 is coupled to one of the branches 87 of the forking device 79. The flow cells 63, 65, and 67 are operated in a co-current flow manner. By this, additionally, the forking device 79 can couple the capillaries 17 and the wave guides 13 of the flow cells 63, 65, and 67 of the arrangement as shown in FIG. 8.

Advantageously, undesired side effects, for example caused or influenced by the direction of the streaming fluid and/or variation of the composition of the fluid, can be reduced, compensated and/or eliminated by accordingly arranging the flow cells, for example as shown in the Fig. above, and evaluating the signals of coupled detectors.

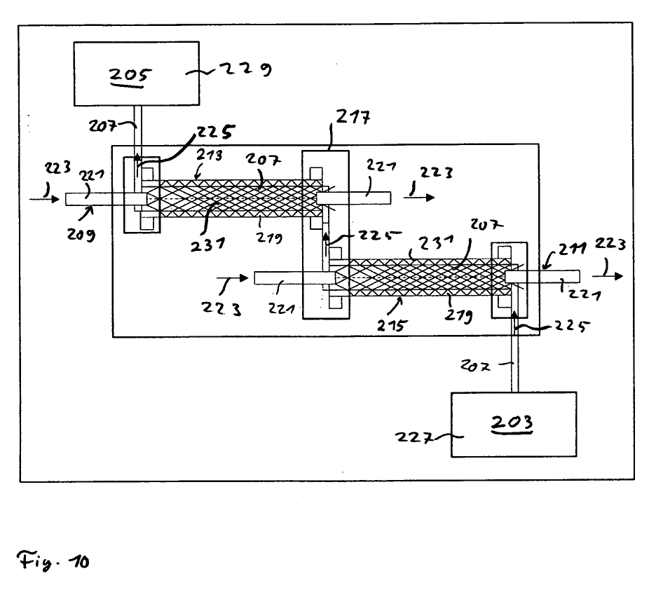

FIG. 10 shows a fluidic system 201 comprising a fluid source 203, for example a pump, a nanopump, and/or alike, and a fluid sink 205, for example a waste or a downstream coupled device, for example for analysis purposes.

Between the fluid source 203 and the fluid sink 205, the fluidic system 201 comprises a fluid path 207. The fluid path 207 is coupled with at least one light path 209. Possibly, the fluid path 207 of the fluidic system 201 can be coupled with a second light path 211. The fluid path 207 and the first and second light paths 209 and 211 belong to a first and a second flow cell 213 and 215.

For coupling the fluid path 207 and the first and second light paths 209 and 211, the fluidic system 201 comprises at least one coupling 217. The coupling 217 can be realized according to one of the couplings according to the Figures above.

Each of the flow cells 213 and 215 comprises a capillary 219 and comprises a wave guide 221. The capillaries 219 of the first and second flow cells 213 and 215 are adapted for conducting a fluid, for example, a fluid comprising a sample, for example, a sample dissolved in a liquid. For analyzing the sample of the fluid, the fluid can be irradiated by the wave guides 221 of the light paths 209 of the first and second flow cells 213 and 215. For measuring the amount of light guided through the fluid sample, the light paths 209 can be connected to not shown light detectors.

The wave guide 221 can also be an optical element like a window, glass rod, and/or alike.

Furthermore, the coupling/s 217 can comprise a plurality of communicating branches, for example, for coupling the capillaries 219, the wave guides 213, and/or according supplying or rather draining conduits to each other.

The direction of the light guided though the light paths 209 of the first and second flow cells 213 and 215 is indicated by arrows 223. The direction of the fluid guided though the fluid paths 207 of the first and second flow cells 213 and 215 is indicated by arrows 225. Besides this, different beams of the light paths 209 are indicated by lines 231.

The capillaries 219 of the first and second flow cells 213 and 215 can comprise a transparent material, for example glass, quartz glass, and/or alike, wherein within the walls of the capillaries total reflection can occur as shown by the beams as indicated by the lines 231 of FIG. 10.

The fluid source 203 can comprise a separating device 227 and/or can be coupled with such a device. Besides this, the fluid sink 205 can comprise an analyzing device 229, for example, a mass spectrograph. The fluidic system 201 can be realized as an integrated system for analysis purposes, for example as a integrated system commercially available, for example, a chromatographic system (LC), a high performance liquid chromatographic (HPLC) system, an HPLC arrangement comprising a chip and an mass spectrograph (MS), a high throughput LC/MS system, a purification system, a micro fraction collection/spotting system, a system adapted for identifying proteins, a system comprising a GPC/SEC column, a nanoflow LC system, and/or a multidimensional LC system adapted for separation of protein digests.

The fluidic system 201 can be adapted for analyzing liquid. More specifically, the fluidic system 201 can be adapted for executing at least one microfluidic process, for example an electrophoresis and/or a liquid chromatographic process, for example a high performance liquid chromatographic process (HPLC). Therefore, the fluidic system 201 can be coupled to a liquid delivery system, in particular to a pump, and/or to a power source. For analyzing liquid or rather one or more components within the liquid, the fluidic system 201 can comprise a detection area, such as an optical detection area and/or an electrical detection area being arranged close to a flow path within the fluidic system 201. Otherwise, the fluidic system 201 can be coupled to a laboratory apparatus, for example to a mass spectrometer, for analyzing the liquid. For executing an electrophoresis, the flow path can comprise a gel. Besides this, the fluidic system can be a component part of a laboratory arrangement.

It is to be understood, that this invention is not limited to the particular component parts of the devices described or to process steps of the methods described as such devices and methods may vary. It is also to be understood, that different features as described in different embodiments, for example illustrated with different Fig., may be combined to new embodiments. It is finally to be understood, that the terminology used herein is for the purposes of describing particular embodiments only and it is not intended to be limiting. It must be noted, that as used in the specification and the appended claims, the singular forms of “a”, “an”, and “the” include plural referents until the context clearly dictates otherwise. Thus, for example, the reference to “a coupling” or “a fluid path” may include two or more such functional elements.

What is claimed is:

1. A coupling for bringing a first conduit in communication with a second conduit, each conduit comprising an end to be coupled and each conduit being adapted for conducting a fluid, the coupling comprising:
a channel adapted for channeling said fluid from said first conduit into said second conduit,
a seal adapted for sealing and receiving said ends of said first and second conduits, and adapted for sealing said channel.

2. The coupling of claim 1, further comprising at least one of:
a first aperture adapted for partly receiving said first conduit,
a second aperture adapted for partly receiving said second conduit,
said first and second apertures each comprise a groove,
said first and second apertures each comprise a half-pipe shaped groove,
a recess surrounding said channel,
said recess encloses said seal,
an undercut adapted for fixing said seal within said recess in a form fitting manner,
a plurality of grooves, wherein each of said grooves is adapted for partly receiving one conduit of a plurality of conduits,
each of said grooves is coupled to said recess,
a half shell and a cover shell,
said half shell and said cover shell comprising said recess,
said half shell and said cover shell comprising said grooves,
said half shells are coated at least partly with an adhesive agent and/or protective coating,
a support member,
said recess surrounds said support member at least partly,
said support member is surrounded at least partly by said seal,
said support member is coated at least partly with an adhesive agent and/or protective coating,
each of said conduits comprises an end comprising an outlet,
said support member is adapted for partly receiving said ends of said first and second conduits and comprises said channel,
said channel is adapted for fluidically coupling said ends of said first and second conduits,
said recess is adapted for truly receiving said seal,
said recess and said seal are donut-shaped,
said recess is adapted for receiving said seal and wherein said seal is arranged within said recess,
said support member and said cover support member are adapted for providing a rib adapted for separating at least one of said ends of said coupled first and second conduits and the channel from said seal,
said seal comprises a plurality of layers,
said seal comprises a plurality of layers embedded in recesses of the shells of the coupling,
said seal comprises said channel,
at least one layer of the seal comprises said channel,
a slit or loop of said at least one layer of said seal provides said channel,
a groove of said at least one layer of said seal provides said channel.

3. The coupling of the above claim, wherein said channel comprises a forking for providing a splitting device for the fluid path.

4. The coupling of claim 2, wherein said support member is adapted for at least one of: positioning said first and second conduits, supporting said first and second conduits, separating said outlets and said fluidic channel from said seal.

5. The coupling of claim 1, further comprising at least one of:
at least one of said conduits is adapted for conducting light,
a first wave guide adapted for conducting said light,
a second wave guide adapted for conducting said light,
a first capillary adapted for conducting at least one of: said light and said fluid,
a second capillary adapted for conducting at least one of: said light and said fluid,
inner tubes of said first and second capillaries comprise a similar cross-sectional area as said channel,
said first and second capillary are fluidically coupled by said fluidic channel,
said first wave guide is arranged coaxially to said first capillary,
said second wave guide is arranged coaxially to said second capillary,
said first wave guide and said first capillary are arranged in parallel to said second capillary and said second wave guide,
said first and second conduits comprise a first capillary and a second capillary adapted for conducting at least one of: said light and said fluid,
said first wave guide is inserted into said first capillary and arranged coaxially to said first capillary,
said second wave guide is inserted into said second capillary and arranged coaxially to said second capillary,
an optical outlet of said first wave guide is inserted into said first capillary,
an optical outlet of said second wave guide is inserted into said second capillary.

6. The coupling of claim 1, further comprising a plurality of conduits comprising a plurality of capillaries with a plurality of fluidic outlets, wherein said fluidic channel comprises a multiple forking adapted for fluidically connecting said plurality of outlets.

7. The coupling of claim 1, further comprising at least one of:
said seal comprises a sealing material,
said sealing material comprises a plastic material that was heated for at least one of: at least partly plastifying, at least partly melting; and thereafter solidified,
said sealing material comprises at least one of: a thermoplastic material, polyetheretherketone (PEEK), one of a broad range of flouropolymeres, in particular perfluoroamines (PFA) or flourinated ethylen-propylene copolymer (FEP), duroplastic material or compound, in particular polyimide, liquid crystal polymers (LCP).
said seal comprises an elastomeric material,
said seal comprises an elastic material,
said elastomeric or elastic material is pressurized by at least one pin inserted into a bore of one of said half shells leading into said cavity,
said seal comprises a low pressure seal comprising said elastomeric material and a high pressure seal comprising an adhesive,
said low pressure seal comprises a soft thermoplastic material like Teflon.

8. A fluidic system adapted for handling a fluid, comprising:
a coupling adapted for at least one of: coupling, connecting, sealing, fixing, adjusting, aligning, receiving, protecting, positioning a first conduit,
the coupling comprising: a channel adapted for channeling said fluid from said first conduit into said second conduit, a seal adapted for sealing and receiving said ends of said first and second conduits, and adapted for sealing said channel.

9. The fluidic system of the above claim adapted for analyzing a fluid, comprising a flow cell for housing a fluid sample and for exposing said fluid sample to radiation for analysis, the flow cell comprising:
a capillary adapted for conducting said fluid sample,
a light path comprising said capillary, a first and a second light guide each adapted for conducting said light into and out of said flow cell,
a fluid path comprising said capillary,
said coupling is adapted for coupling said light path and said fluid path,
said coupling comprises said first aperture coupled to one end of said analysis capillary, a second aperture coupled to one of said light guides, and said channel coupled to said capillary and to a supplying conduit.

10. The fluidic system of claim 8, comprising at least one of the following:
two of said couplings,
at least two of said flow cells,
at least two of said flow cells coupled by at least one of said couplings,
said couplings comprise each a plurality of communicating branches,
a supplying conduit adapted for conducting said fluid sample into said capillary,
said flow cell comprises a housing for supporting, positioning, and surrounding said capillary and said couplings.

11. The fluidic system of claim 8, further comprising
a fluid delivery system,
a separation device for separating components of said fluid delivered by said fluid delivery system, and
the flow cell adapted for detecting said separated components within said fluid.

12. The fluidic system of the above claim, wherein said fluidic system is or comprises at least one of:
a chromatographic system (LC),
a high performance liquid chromatographic (HPLC) system,
an HPLC arrangement comprising a chip and an mass spectrograph (MS),
a high throughput LC/MS system,
a purification system,
a micro fraction collection/spotting system,
a system adapted for identifying proteins,
a system comprising a GPC/SEC column,
a nanoflow LC system,
a multidimensional LC system adapted for separation of protein digests.
